(19) United States
(12) Patent Application Publication
(10) Pub. No.: US 2002/0095502 A1
(43) Pub. Date: Jul. 18, 2002

(54) Business-to-business service provider system for intranet and internet applications

(76) Inventor: James S. Chester, Lutz, FL (US)

Correspondence Address: Jay H. Anderson, International Business Machines Corporation, 2070 Route 52, Hopewell Junction, NY, 12533, US

(21) Appl. No.: 09/760,979

(22) Filed: Jan. 16, 2001

(51) Int. Cl. G06F 15/16

(52) U.S. Cl. 709/227; 709/203

(57) ABSTRACT

A system and method are described for establishing a secure virtual trading zone for customers of a service provider, in which bandwidth and applications are provided dynamically and in which the communication path is controlled. The service provider performs the following steps: receiving a request from a customer to establish communication with another customer; confirming the identity of each customer; transmitting to each customer executable code enabling encrypted communication therewith; obtaining from each customer information regarding the customer's computing environment; preparing a set of applications for use by each customer, in accordance with the customer information and the customer's request; transmitting the set of applications as executable code to each customer; establishing a communication path to each customer; and specifying the communication path to the customers, thereby permitting the customers to communicate over the path using those applications.

### FIELD OF THE INVENTION

This invention relates to business-to-business (“B2B” or “enterprise”) electronic communication, and more particularly to a system for providing a secure virtual trading zone between enterprises.

### BACKGROUND OF THE INVENTION

The Internet refers to the network of computers that arose out of the network created by the Advanced Research Project Agency (ARPA) using the Transmission Control Protocol/Internet Protocol (TCP/IP) as the method for providing communication between the computers on the network. Other networks limit access to members of a particular organization; these networks are known as intranets and also commonly use TCP/IP.

FIGS. 1A and 1B are conceptual diagrams of two possible ways for organizations A and B, each having its own intranet 10, 20 respectively, to communicate (share data, transact business, etc.). The Internet 1 has a multiplicity of computers with a very large number of connections among them, with data traveling over a very large number of possible paths. In FIG. 1A, business partners A and B communicate over a direct link 15 (e.g. a dedicated voice/data line) which does not involve the Internet 1. An advantage of this approach is that the communication path is known and controlled by the partners, and is relatively easy to keep secure. Disadvantages include the cost of maintaining the link 15, and the difficulty of utilizing applications. In the scheme of FIG. 1A, an application used by one of the business partners must be resident on one of the intranets 10, 20 (as opposed to downloading the application via the Internet whenever the application is desired).

FIG. 1B shows a situation where business partners A and B communicate using the Internet 1 to establish a “virtual trading zone.” Information traveling between A and B follows a path 101, through a number of computers 110, which in general is constantly changing and difficult to keep secure. Since A and B may wish to share sensitive information, providing secure access to intranets 10 and 20 is of great concern. Accordingly, A and B each protect themselves with a suite of applications to provide security for their intranets and their users. These applications, collectively termed “firewalls,” are shown schematically as walls 12 and 22 in FIG. 1B. In contrast to FIG. 1A, the communication path is generally unknown and not under the control of the partnering organizations.

In the scheme of FIG. 1B, many applications and services are available to business partners A and B via other computers and networks connected to the Internet. For example, one or more of the computers 110 accessed by partners A and B may represent a supplier of a commerce-enabling application (e.g. e-mail, financial analysis tools, etc.). Another supplier may be a vendor of bandwidth, thereby enabling traffic between A and B at a particular rate. However, these applications and services are generally not integrated and not coordinated with each other. In particular, a bandwidth vendor is generally unable to dynamically provide access to a selected application. Accordingly, the scheme of FIG. 1B is unable to provide a dynamically configured, time-duration-limited trading zone. In addition, a very large number of other computers 120 are not part of the path between A and B, and are not needed for their transactions. Stated another way, enterprises A and B do not need the entire Internet but need only a source for their required applications and a path along which they may communicate.

There remains a need for a system which establishes a secure virtual trading zone for business partners, in which bandwidth and applications are provided dynamically and in which the communication path is controlled by the partners or by a trusted service provider.

### SUMMARY OF THE INVENTION

The present invention provides a system and a method for use by a service provider, to facilitate communications between customers of the service provider.

In accordance with a first aspect of the invention, a method is described which includes the following steps: receiving a request from a customer to establish communication with another customer; confirming the identity of each customer; transmitting to each customer executable code enabling encrypted communication therewith; obtaining from each customer information regarding the customer's computing environment; preparing a set of applications for use by each customer, in accordance with the customer information and the customer's request; transmitting the set of applications as executable code to each customer; establishing a communication path to each customer; and specifying the communication path to the customers, thereby permitting the customers to communicate over the path using those applications.

It will be appreciated that communications between the service provider and the customers will typically be conducted via the Internet. Accordingly, the above-described steps of confirming, transmitting and obtaining may be performed via the Internet; furthermore, the establishing step may include obtaining connectivity services via the Internet for use by the customers, and altering the communication path in accordance with customer requirements. The customer information may be obtained using an applet resident at the customer. The connectivity services may be obtained by contacting a vendor of those services via the Internet.

It is noteworthy that in the practice of this method, the communication path may be established for only a limited time period. In addition, in the step of preparing the set of applications, at least one of the applications may be obtained via the Internet. Alternatively, one or more of the applications may be obtained from a storage device connected to the server. The communication path may also be monitored. In a preferred embodiment of the invention, the specified communication path is established on the Internet and communications using the path are encrypted, so that the customers participate in a secure virtual trading zone.

The method of the present invention is advantageously practiced using an edge-of-network server.

In accordance with another aspect of the invention, a system is provided for facilitating communications between customers of a service provider. The system includes a server which is enabled to perform the method described above. The system may include a dedicated link to a provider of connectivity services. The system may also include a storage device from which the server obtains at least one of the applications for use by the customers. As noted above, the server may be characterized as an edge-of-network server.

In accordance with an additional aspect of the invention, a computer program product is provided which includes instructions for performing the above-described method.

### BRIEF DESCRIPTION OF THE DRAWINGS

FIG. 1A shows a scheme for business-to-business connectivity between two business partners in which a dedicated communication link is used.

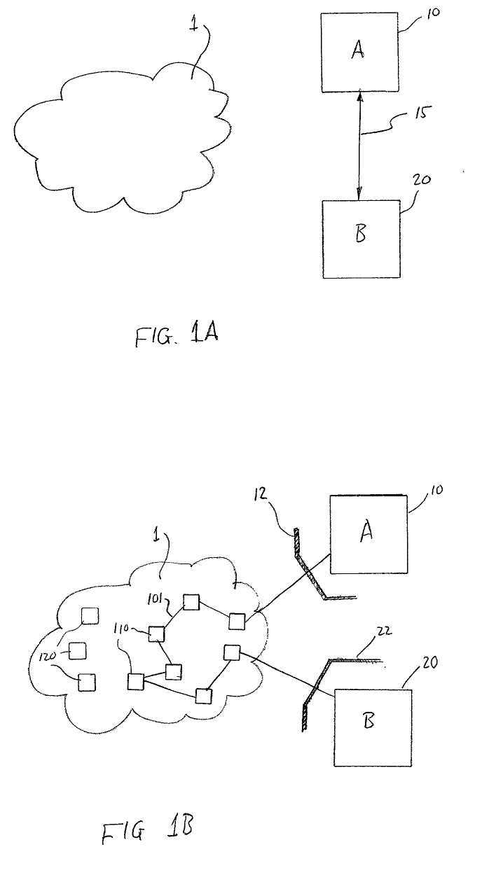

FIG. 1B shows a scheme for business-to-business connectivity between two business partners in which the Internet is used.

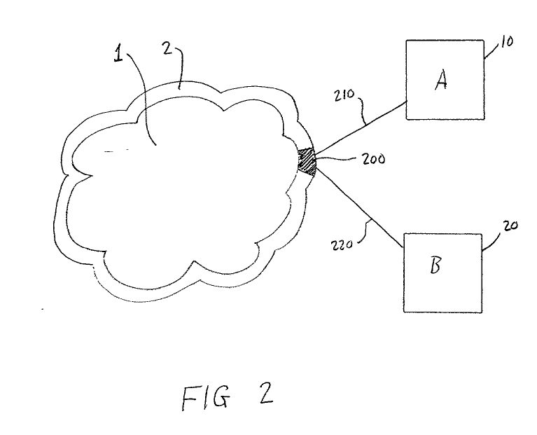

FIG. 2 is a conceptual diagram showing two business partners connected to an edge-of-network (EoN) service provider, in accordance with the present invention.

FIG. 3 shows steps in a process by which the EoN service provider establishes a secure virtual trading zone for business partners A and B, in accordance with the present invention.

FIGS. 4A-4D schematically illustrate the service provider executing the steps in the process of FIG. 3.

### DETAILED DESCRIPTION OF THE PREFERRED EMBODIMENTS

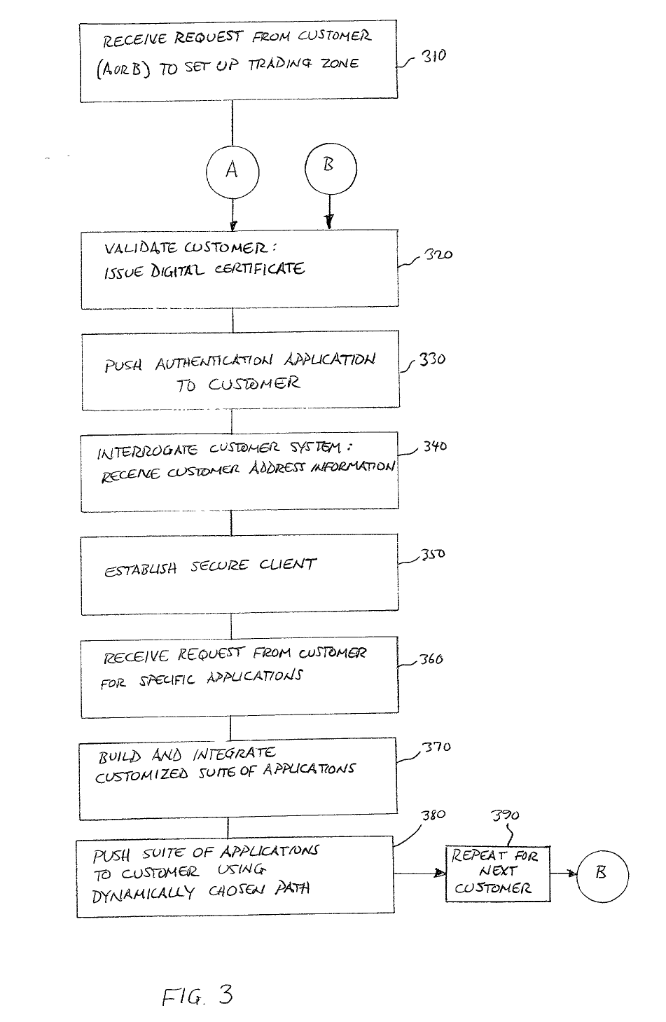

FIG. 2 is a conceptual illustration of an embodiment of the present invention. The intranets 10, 20 of business partners A and B are connected (using non-dedicated links 210, 220) to a service provider 200. Service provider 200 provides secure connectivity between, and delivers desired applications to, partners A and B (who may be viewed is customers or clients of provider 200). The service provider 200 controls the communication path between A and B, and furthermore ensures the security of the communications. Since the communication path is established and controlled by provider 200, the service provider is said to be at the edge 2 of Internet 1, and is commonly referred to as an “edge of network” (EoN) service provider.

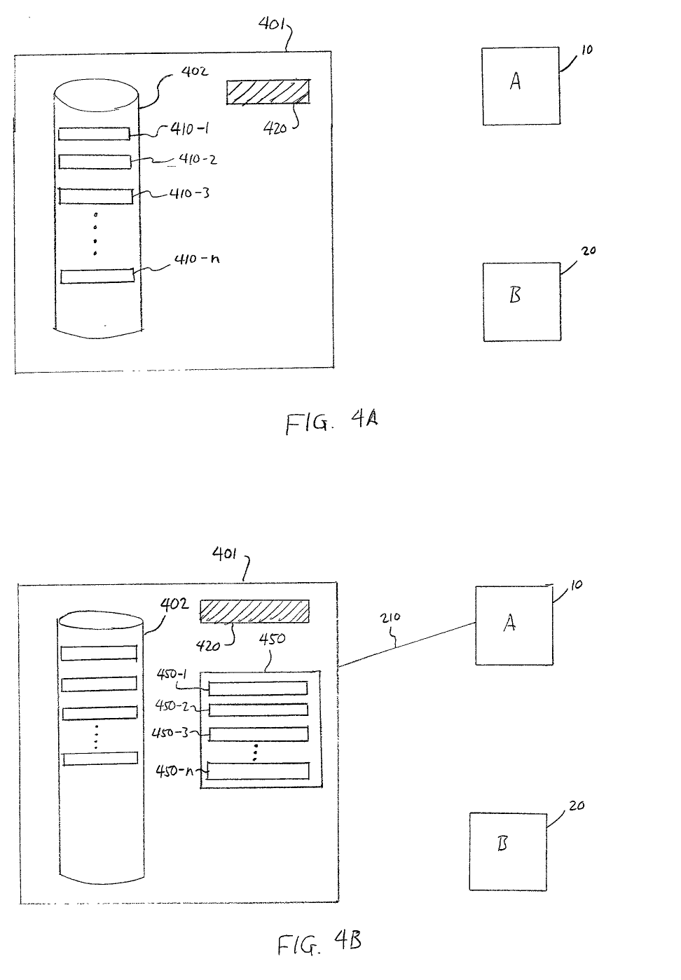

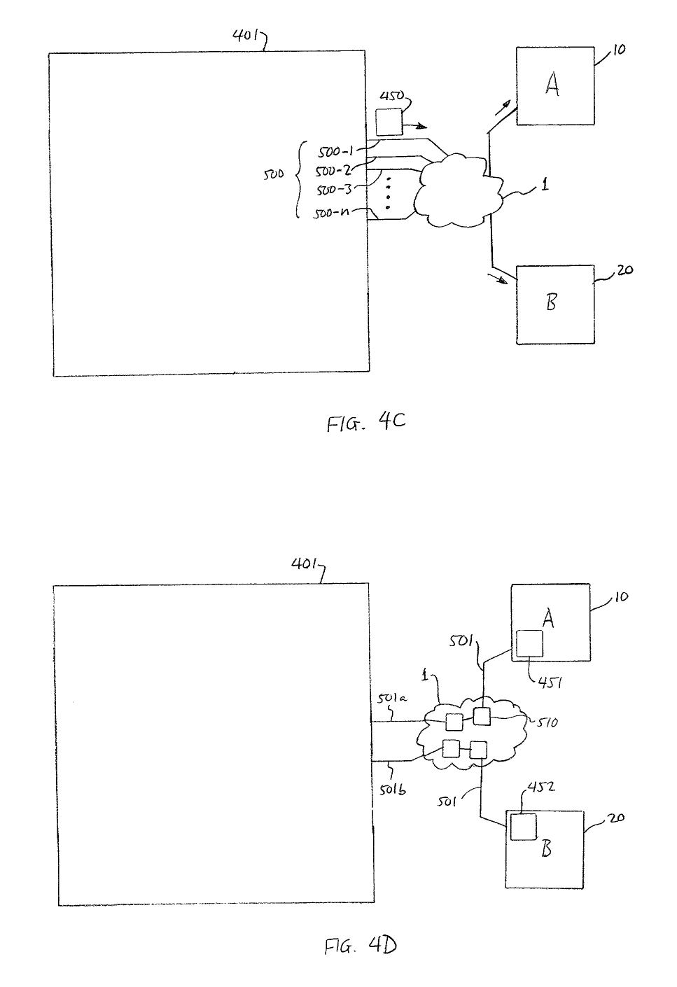

The service provider 200 establishes a secure virtual trading zone by a process shown in FIG. 3. The service provider 200 is physically embodied in a service delivery center (SDC) including one or more servers 40 1, as shown schematically in FIG. 4A. The server 401 includes one or more storage devices 402, on which are resident a number of applications 410-1, 410-2, . . . 410-n. The server is enabled to perform this process by software 420 resident on the server. Generally, server 401 is remote from both intranets 10 and 20.

It is assumed that the two enterprises A and B have already agreed between them to set up a virtual trading zone. The SDC receives a request from one of them to begin this process (FIG. 3, step 310). The SDC responds by first validating the identity of the requesting party. This may be done by comparing an ID code or password, transmitted by the customer, with a list of authorized customers. If the requesting customer (in this example, A) is known, the SDC issues a digital certificate to the customer (step 320).

The SDC then pushes an executable authentication application to the customer (step 330). This application is used to examine the digital certificate in subsequent communications between the SDC and the customer, thereby maintaining a secure environment.

The SDC then “interrogates” the customer to obtain important information regarding the customer's system (step 340). The interrogation may be done using an applet previously installed at the customer. The SDC collects information regarding the customer's operating system, memory capacity, virus protection and existing applications. Furthermore, the SDC obtains the customer's dynamically assigned Internet Protocol (IP) address. The SDC also pushes an executable “secure client” to the customer which includes an encryption capability (step 350). This step is preferably performed simultaneously with the interrogation of step 340. At this point all transmissions between the customer and the service provider are encrypted and have their origin authenticated. Accordingly, the service provider has identified the customer, has established secure communication with the customer, and has gathered sufficient information about the customer to build a customized suite of applications for the customer's use.

The customer then transmits a request to the SDC specifying the applications that are desired (step 360). The SDC immediately builds a customized suite of applications (step 370), in accordance with the information provided by the customer in the interrogation step. Alternatively, the SDC may prepare a standard suite of applications, with any modifications necessary to ensure successful use by the customer. The applications are obtained directly from the storage device 402; alternatively, they may be downloaded from a remote server via the Internet. FIG. 4B is a schematic illustration of an integrated, customized suite 450 including applications 450-1, 450-2, 450-3, . . . 450-n, resident on server 401 and ready to be delivered to the customer. As shown in FIG. 4B, at this point there is communication between server 401 and customer A's intranet 10 along communication link 210, but there is no communication between A and B.

The entire integrated suite of applications 450 (that is, a package of executable code) is then pushed to the customer (step 380). It is noteworthy that this push may be performed on the Internet and along any convenient path; the routing of the push may be dynamically chosen. As illustrated schematically in FIG. 4C, server 401 may be linked to the Internet 1 by a plurality of communication paths 500-1, 500-2, 500-3, . . . 500-n. The path that is chosen at a given moment will depend upon several factors including bandwidth requirements, speed, cost, etc.

The above-described steps in FIG. 3 are then repeated for each of the other customers (step 390). The customers thus have suites of applications 451, 452 installed on their respective intranets 10, 20, as shown in FIG. 4D.

The service provider then finds an appropriate path 501 along which A and B may communicate. This is done by obtaining the required bandwidth from a bandwidth vendor; the SDC contacts the vendor over the Internet 1 using one of the links 500. The chosen path 501 runs through server 401, and in general through one or more computers 510 on the Internet. FIG. 4D shows a general case where the paths 501a, 501b to server 401 from A and B use different links. Alternatively, the same link may be used to connect to both business partners.

It is noteworthy that the service provider uses the Internet to broker connectivity between customers A and B, as opposed to A and B connecting to the Internet themselves and thus using an uncontrolled path. The path 501 is chosen and constantly monitored by the SDC; the authentication application is used to point out the path to A and B. The path may be changed dynamically whenever required. For example, A or B may signal the SDC that more or less bandwidth is needed due to an increase or decrease in traffic, or that the path will no longer be used since transactions have been completed. In choosing a desirable path, speed and cost are basic considerations. The service provider maintains the integrity of the path by 1) monitoring link saturation, 2) monitoring path latency, and 3) providing alternate paths if necessary. It should be noted that traffic between A and B is encrypted, regardless of the path 501.

As shown in FIG. 4D, transactions between enterprises A and B are carried on in a virtual trading zone (that is, using application suites 451, 452 and communicating over path 501) whose integrity is established and monitored by the SDC embodied in server 401. The virtual trading zone is used only as long as it is needed, and may then be dismantled (that is, paths are discontinued so that the situation reverts to that shown in FIG. 4A).

An advantage of the present invention is that the enterprises (in this example, A and B) have a network built for their use, with all the desired applications for transacting business, which exists only as long as it is required. A and B receive packages of executable code over existing physical channels of communication and over a known path. Enterprises A and B therefore realize the advantages of the Internet by contacting an edge-of-network service provider.

While the present invention has been described in conjunction with specific preferred embodiments, it would be apparent to those skilled in the art that many alternatives, modifications and variations can be made without departing from the scope and spirit of the invention. Accordingly, the invention is intended to encompass all such alternatives, modifications and variations which fall within the scope and spirit of the invention and the following claims.

We claim:

1. A method for use by a service provider to facilitate communication between customers of the service provider, the method comprising the steps of:
receiving a request from a customer to establish communication with another customer;
confirming the identity of each customer;
transmitting to each customer executable code enabling encrypted communication therewith;
obtaining from each customer information regarding the customer's computing environment;
preparing a set of applications for use by each customer, in accordance with said information and said request;
transmitting the set of applications as executable code to each customer;
establishing a communication path to each customer; and
specifying the communication path to the customers, thereby permitting the customers to communicate over said path using said applications.

2. The method of claim 1 wherein said confirming, transmitting and obtaining steps are performed via the Internet, and said establishing step comprises
obtaining connectivity services via the Internet for use by the customers; and
altering the communication path in accordance with customer requirements.

3. The method of claim 2 wherein the connectivity services are obtained by contacting a vendor of said services via the Internet.

4. The method of claim 1 wherein the communication path is established for a limited time period.

5. The method of claim 1 wherein said preparing step comprises obtaining at least one of the applications via the Internet.

6. The method of claim 1 wherein said method is performed using an edge-of-network server.

7. The method of claim 6 wherein said preparing step comprises obtaining at least one of the applications from a storage device connected to the server.

8. The method of claim 2 wherein the specified communication path is established on the Internet and communications using the path are encrypted, so that the customers participate in a secure virtual trading zone.

9. The method of claim 1 further comprising the step of monitoring the communication path.

10. The method of claim 1 wherein said obtaining step is performed using an applet resident at the customer.

11. A system for facilitating communication between customers of a service provider, the system comprising:
a server connected to the Internet, the server being enabled to perform a method including the steps of
receiving a request from a customer to establish communication with another customer,
confirming the identity of each customer,
transmitting to each customer executable code enabling encrypted communication therewith,
obtaining from each customer information regarding the customer's computing environment,
preparing a set of said applications for use by each customer, in accordance with said information and said request,
transmitting the set of applications as executable code to each customer,
establishing a communication path to each customer, and
specifying the communication path to the customers, thereby permitting the customers to communicate over said path using said applications.

12. The system of claim 11, further comprising a dedicated communication link to a provider of connectivity services.

13. The system of claim 11 wherein said server performs the confirming,
transmitting and obtaining steps via the Internet, and the establishing step comprises
obtaining connectivity services via the Internet for use by the customers; and
altering the communication path in accordance with customer requirements.

14. The system of claim 13 wherein the server obtains the connectivity services by contacting a vendor of said services via the Internet.

15. The system of claim 11 wherein the communication path is established for a limited time period.

16. The system of claim 11 wherein in the preparing step the server obtains at least one of the applications via the Internet.

17. The system of claim 11 wherein said server is an edge-of-network server.

18. The system of claim 11, further comprising a storage device connected to the server, and in the preparing step the server obtains at least one of the applications from said storage device.

19. The system of claim 11 wherein the server is enabled to establish the specified communication path on the Internet with communications using the path being encrypted, so that the customers participate in a secure virtual trading zone.

20. The system of claim 11 wherein the server is enabled to monitor the communication path.

21. The system of claim 11 wherein the server obtains the customer information using an applet resident at the customer.

22. A computer program product comprising instructions for performing a method to facilitate communication between customers of a service provider, the method comprising the steps of:
receiving a request from a customer to establish communication with another customer;
confirming the identity of each customer;
transmitting to each customer executable code enabling encrypted communication therewith;
obtaining from each customer information regarding the customer's computing environment;
preparing a set of applications for use by each customer, in accordance with said information and said request;
transmitting the set of applications as executable code to each customer;
establishing a communication path to each customer; and
specifying the communication path to the customers, thereby permitting the customers to communicate over said path using said applications.

23. The computer program product of claim 22 wherein said confirming,
transmitting and obtaining steps are performed via the Internet, and said establishing step comprises
obtaining connectivity services via the Internet for use by the customers; and
altering the communication path in accordance with customer requirements.

24. The computer program product of claim 23 wherein the connectivity services are obtained by contacting a vendor of said services via the Internet.

25. The computer program product of claim 22 wherein the communication path is established for a limited time period.

26. The computer program product of claim 22 wherein said preparing step comprises obtaining at least one of the applications via the Internet.

27. The computer program product of claim 22 wherein said method is performed using an edge-of-network server.

28. The computer program product of claim 27 wherein said preparing step comprises obtaining at least one of the applications from a storage device connected to the server.

29. The computer program product of claim 23 wherein the specified
communication path is established on the Internet and communications using the path are encrypted, so that the customers participate in a secure virtual trading zone.

30. The computer program product of claim 22 wherein the method further comprises the step of monitoring the communication path.

31. The computer program product of claim 22 wherein said obtaining step is performed using an applet resident at the customer.
